(19) United States
(12) Patent Application Publication
(10) Pub. No.: US 2002/0064152 A1
(43) Pub. Date: May 30, 2002

(54) Packet voice gateway

(76) Inventors: Donald G. Lemley, Aurora, IL (US); Kenneth G. Craft, Naperville, IL (US); William Kautz, St. Charles, IL (US); Timothy J. Doiron, Aurora, IL (US); Alan S. Nakamoto, Naperville, IL (US)

Correspondence Address: Kenneth J. Rudofski, Tellabs Operations, INc., 1415 West Diehl Road, MS 16, Naperville, IL, 60563, US

(21) Appl. No.: 09/996,173

(22) Filed: Nov. 27, 2001

Related U.S. Application Data
(60) Provisional application No. 60/253,691, filed on Nov. 28, 2000.

(51) Int. Cl. H04L 12/56

(52) U.S. Cl. 370/352; 370/401; 370/465

(57) ABSTRACT

Disclosed is a novel Packet Voice Gateway (PVG) that is adapted for the line side of the communication network, such as for example in a Digital Loop Carrier Terminal, which provides functionality that can effectively bridge service between a circuit switched based access network and a packet based public network. The ability to so bridge service using the PVG of the present invention allows service operators to extend their circuit switched capital investment by enabling such equipment to be used in connection with a packet based public network.

### CROSS-REFERENCE TO RELATED APPLICATIONS

This application claims the benefit under 35 U.S.C. 119(e) of U.S. Provisional Application No. 60/253,691, filed Nov. 28, 2000.

### FIELD OF THE INVENTION

The present invention relates to communication networks. In particular, the present invention relates to packetized voice and data communication networks.

### BACKGROUND OF THE INVENTION

For years, the public switched telephone network of the U.S. has provided reliable two-way telephony service. This network is made up of various types of well-known telephony switching systems and well-known physical media over which are carried electrical signals representing voice-frequency information.

Many telephone companies use Digital Loop Carrier (DLC) systems for example to provide telephone services to their customers.

In recent years, Multiple System Operators (MSOs) have begun to offer Primary Line residential telephony services using well-known telephony switching systems and circuit switched access equipment (DLC technology) adapted for use over Hybrid-Fiber Coax (HFC) networks.

At the headend or hub, a Host Digital Terminal (HDT) interfaces a local telephony switching system. The HDT effectively manages telephone conversations and data traffic, and provides full interoperability with the appropriate backbone networks (PSTN or data network).

Today, most HDT modems utilize QPSK technology to modulate the digital signals into narrowband RF carriers for both downstream and upstream channels. Circuit switched timeslots (64 Kbps) are multiplexed into a single multi-megabit digital stream and modulated into a 1.5 MHz wide RF carrier for straightforward insertion in the downstream path. HFC systems typically support downstream carriers in the 470 MHz to 862 MHz range.

A remote service unit (RSU) at the subscriber location receives all of the downstream signals via standard coaxial drop. The RSU locates its assigned telephony RF carrier for demodulation and passes the downstream RF to other devices (i.e. set top box, television set, etc.). The RSU shares the digital bandwidth with other RSUs on the same RF carrier frequency. The digital bandwidth is used only when telephones are “off hook”. For circuit switched cable telephony services, 64 Kbps is used for connectivity between standard telephony line interfaces in the RSU and the local telephony switch. Data services can utilize the remaining unused bandwidth, providing very efficient use of the digital pipe.

In the upstream direction, the RSU transmits digital voice and data signals to the HDT via narrowband RF carriers (typically between 5 and 42 MHz) using QPSK modulation and TDMA multiplexing. The digital bursts from multiple RSUs transmitters are received by a modem in the HDT, creating a shared multi-megabit two-way transmission path. The HDT modem manages each RSU's packet transmission timing and transmit levels to account for the different distances between the headend and subscribers and variations in the plant over time/temperature.

Migration to packet based HFC networks is underway in the industry to deliver voice, video, and data services. Data Over Cable System Interface Specifications (DOCSIS) have been defined by Cable Television Laboratories, Inc. (“CableLabs”) for equipment that delivers data services over HFC networks. PacketCable interface specifications are at present being defined by CableLabs for equipment that will deliver Voice over IP (VoIP) and future packet based services over DOCSIS equipment. The primary difference between a DOCSIS access system and a circuit switched access system is that the DOCSIS system transports services in the form of IP packets, where the circuit switched access system transports services in the form of traditional Time Division Multiplex (TDM) links.

At the headend or hub, a Cable Modem Termination System with Edge Router (CMTS/ER) communicates through RF channels with cable modems at subscriber homes to create a virtual local area network (LAN) connection. Most cable modems are separate devices to connect to personal computers via an Ethernet or Universal Serial Bus (USB) connection.

DOCSIS CMTSs utilize 64 and 256 Quadrature Amplitude Modulation (QAM) technology to modulate the IP packets into RF carriers for downstream transmission in the HFC network. 64 QAM transmission yields approximately 27 Mbps data throughput in 6 MHz RF spectrum. 256 QAM transmission delivers approximately 36 Mbps data throughput in the same spectrum. Upstream channels can delivery between 500 Kbps and 10 Mbps using Quadrature Phase Shift Key (QPSK) or 16 QAM modulation techniques. The downstream and upstream channels are shared across many cable modems in a cable network segment, usually between 500 homes and 6000 homes.

Telephony and high speed data services are delivered to a subscriber via a Cable Modem with Multimedia Terminal Adapter (CM w/MTA). The MTA converts between voice frequency (VF) signals and IP packets for transmission to and from the HFC network.

The current public switched telephone network in the U.S. was created to provide very reliable telephone service. There is a great deal of research and development activities currently focused on creating a new packet based public network designed to provide services which cannot be offered in the current circuit switched network. However, this new packet based public network will take years to complete. The ability to bridge packet based access networks to the current circuit switched PSTN will accelerate the creation of a new packet based public network by allowing service operators to incrementally build the new infrastructure. The inventors have recognized that to provide the service providers with an effective means to bridge service between circuit switched based access networks and a packet based public network will allow service operators to extend their circuit switched capital investment in the access network by enabling such equipment to be connected to a packet based public network.

### DETAILED DESCRIPTION

Disclosed is a novel Packet Voice Gateway (PVG) that is adapted for the line side of the communication network, such as for example in a Digital Loop Carrier Terminal, which provides functionality that can effectively bridge service between a circuit switched based access network and a packet based public network. The ability to so bridge service using the PVG of the present invention allows service operators to extend their circuit switched capital investment by enabling such equipment to be used in connection with a packet based public network.

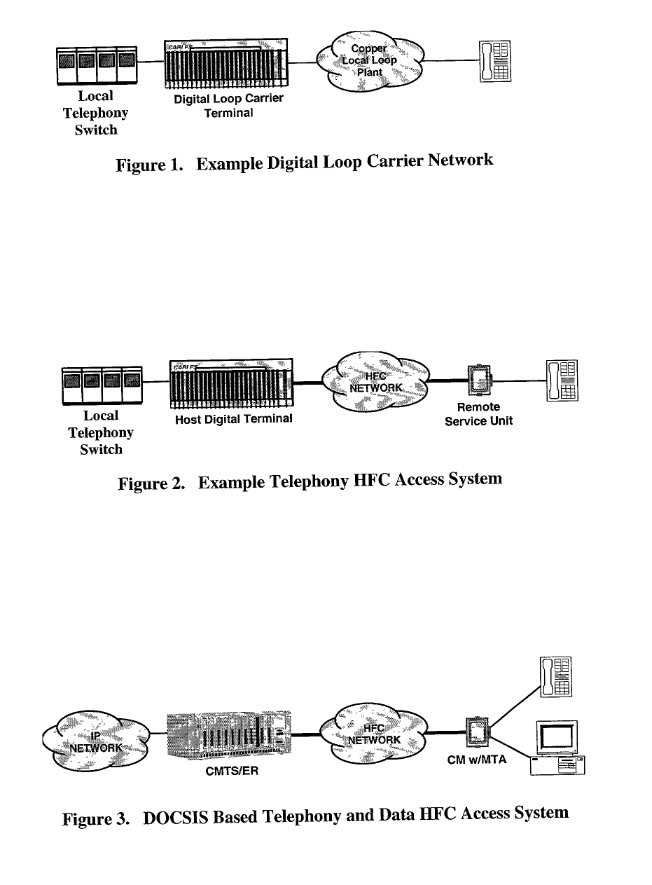

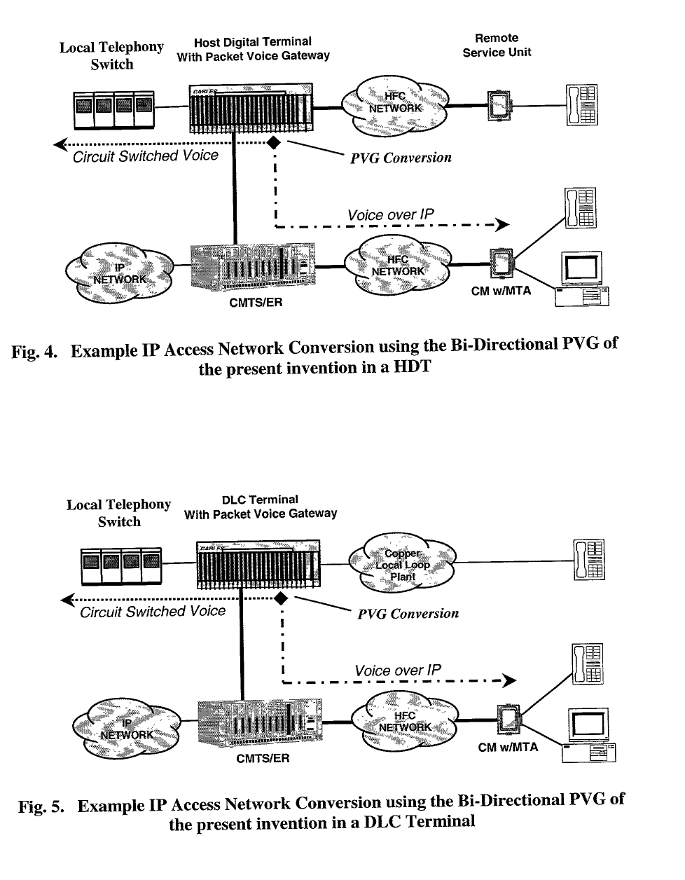

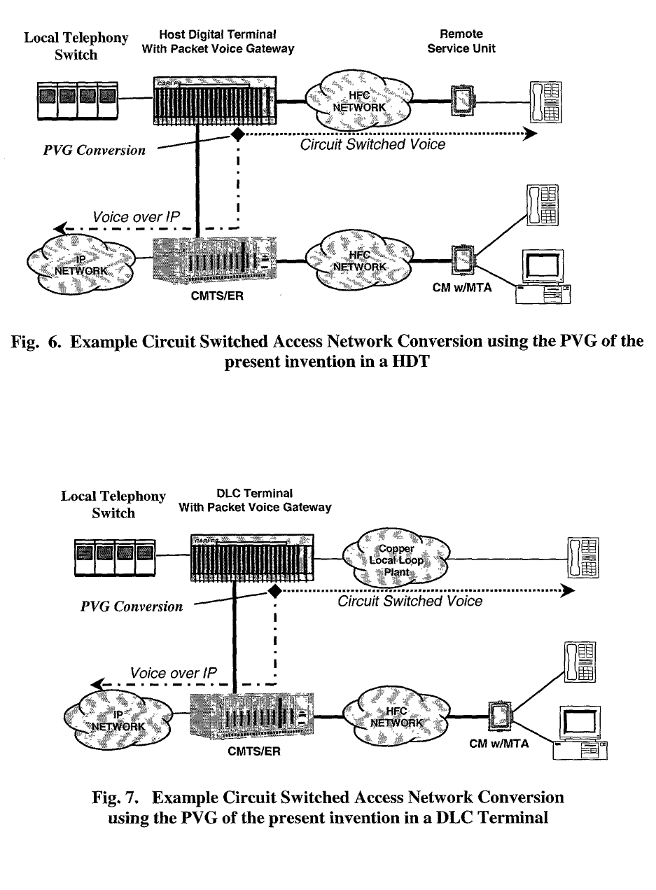

The PVG of the present invention is preferably bidirectional, in that it provides bridging capability for both connecting packet based access networks (such as for example a HFC access network as illustrated in the below figures) to the current circuit switched PSTN and connecting circuit switched based access networks (such as for example the HFC and DLC networks illustrated in the below figures) with the new packet based public network. More specifically by way of illustration, the PVG in the below-illustrated embodiments of the present invention preferably performs: (1) conversion and inter-connection of VoIP signals in DOCSIS HFC networks to circuit switched telephony signals (see FIG. 4 for PVG in HDT context, and FIG. 5 for PVG in DLC terminal context); and (2) conversion and inter-connection of circuit switched telephony signals on cable telephony and DLC systems to Voice over IP telephony signals (see FIG. 6 for PVG in HDT context, and FIG. 7 for PVG in DLC terminal context). If desired, the preferred PVG can simultaneously provide both (1) and (2) conversion and interconnection functionality.

The PVG embodiments illustrated in FIG. 4 (HFC network application) and FIG. 5 (DLC network application) each function to bridge VoIP services provided by CMTS/ER and CM w/MTA equipment to local switching systems (common in the current telephony network). Local telephony service is provided by the local telephony switch. The PVG, shown schematically in the figures as a black diamond, is located on the line side of the network, preferably in the Host Digital Terminal (FIG. 4) or, more generally, the DLC terminal (FIG. 5) for the below-illustrated embodiments. The PVG thus functions to provide circuit switched telephony service to subscribers via packet based access networks.

The PVG embodiments illustrated in FIG. 6 (the bidirectional component corresponding to the HFC network application illustrated in FIG. 4) and FIG. 7 (the bidirectional component corresponding to the DLC network application illustrated in FIG. 5) each function to bridge circuit switched telephony services provided by HDT and RSU equipment (in the case of FIG. 6) or, more generally, DLC terminals (in the case of FIG. 7) to packet based networks (the new public network). Local telephony service is provided via the new packet based public network. The PVG, shown schematically in the figures as a black diamond, is located on the line side of the network, preferably in the Host Digital Terminal (FIG. 6) or, more generally, the DLC terminal (FIG. 7) for the below-illustrated embodiments. The PVG thus functions to provide VoIP based telephony service to subscribers via circuit switched access networks such as HFC or, more generally, DLC.

In operation, the preferred PVG for the embodiments illustrated herein is capable of: (a) converting line side local switch signaling (as provided for example via the common U.S. GR-303 switch interface and/or European V5.2 switch interface) to packet based signaling, such as for example MGCP (Media Gateway Control Protocol) or SGCP (Signaling Gateway Control Protocol) or H.323 or SIP (Session Initiation Protocol), as understood by the CM with MTA in for example the HFC network environment; and (b) converting standard 64 Kbps voice payload (the telephony conversation) to Voice over IP packets. The preferred PVG is also capable of: (c) converting VoIP local telephone service signaling, such as for example MGCP (Media Gateway Control Protocol) or SGCP (Signaling Gateway Control Protocol) or H.323 or SIP (Session Initiation Protocol), to line side local switch signaling (as provided for example via the common U.S. GR-303 switch signaling and/or European V5.2 switch signaling); and (d) conversion of Voice over IP packets to standard 64 Kbps voice payload (the telephony conversation).

Various features of the system can be implemented in hardware, software, or a combination of hardware and software. Moreover, although certain embodiments of the present invention have been described and illustrated herein, it will be readily apparent to those of ordinary skill in the art that modifications and substitutions can be made to the embodiments disclosed and described herein without departing from the true spirit and scope of the invention.

We claim:

1. A packet voice gateway, comprising:
a first port adapted to interface a circuit-switched network;
a second port adapted to interface a packet-based network;
a first converter to convert packet-based signals arriving at the first port to circuit-switched signals;
a second converter to convert circuit-switched signals arriving at the second port to packet-based signals; and
inter-connection circuitry to inter-connect the first and second ports.
